(19) United States
(12) Patent Application Publication
(10) Pub. No.: US 2008/0102256 A1
(43) Pub. Date: May 1, 2008

(54) Coating, coated media, and method for coating media

(76) Inventors: Benjamin T. Liguzinski, Cincinnnati, OH (US); Jay C. Song, Highland Mills, NY (US)

Correspondence Address: INTERNATIONAL PAPER COMPANY, 6285 TRI-RIDGE BOULEVARD, LOVELAND, OH, 45140, US

(21) Appl. No.: 11/974,708

(22) Filed: Oct. 15, 2007

Related U.S. Application Data
(60) Provisional application No. 60/829,482, filed on Oct. 13, 2006.

(51) Int. Cl. G03G 9/00; B32B 3/00; G02B 27/10

(52) U.S. Cl. 428/206; 430/108.1; 430/108.7; 359/619

(57) ABSTRACT

The present invention provides a coating composition, a coated transparent thermoplastic electrophotographic recording medium, for example, a coated lenticular lens electrophotographic recording medium, and a method for coating the transparent thermoplastic electrophotographic recording medium.

### BACKGROUND

1. Field of the Invention

The present invention broadly relates to coating compositions which may be used with transparent thermoplastic electrophotographic recording media for improving the adherence of toner particles to the surface of the media, while maintaining acceptable transparency of the coating, color impression, image quality, etc., when the toner particles are in contact with the coating. The present invention also broadly relates to a transparent thermoplastic electrophotographic recording medium wherein at least one side of the media is coated with this coating composition. The present invention further broadly relates a transparent thermoplastic electrophotographic recording medium comprising a lenticular lens material wherein one surface of the medium comprises a lenticular lens array and wherein the other side of the media has a relatively smooth or flat side which is coated with this coating composition. The present invention further broadly relates to a method for coating one or more sides of a transparent thermoplastic electrophotographic recording medium with this coating composition. The present invention further relates to a method of printing at least one image on the recording media described herein, preferably by electrophotographic means.

2. Related Art

Electrophotography provides a non-impact printing technology for today's reprographic industries. A representative electrophotographic copying or printing process normally creates images on a coated polymeric substrate in five steps. These steps include: (1) depositing a uniform electric charge onto a photoconductor drum; (2) creating an electrostatic latent image on the photoconductor by exposing the photoconductor to an oscillating narrow laser beam that is turned on and off digitally or a stationary array of LED lights which are turned on and off digitally; (3) exposing the photoconductor to toner particles such that toner particles having the correct polarity adhere to the exposed latent image; (4) passing the medium to be printed between the photoconductor and a transfer corona to cause the toner particles to transfer from the photoconductor to the medium; and (5) fixing (e.g., fusing) the transferred toner particles on the medium.

Technological advances in electrophotography have brought an increase in the popularity of color electrophotographic copiers and printers. Unlike a monochrome copier wherein only a single toner i.e. black toner is employed, full color copying may require as many as four toners including yellow, magenta, cyan, and black. Because a separate imaging process may be required for each of the four toners, color copiers and printers may be much slower and more expensive than their monochrome counterparts. The recording media suitable for color copiers or printers may need to meet more stringent requirements to provide a true full-color reproduction of the original.

One use of color electrophotographic copiers or printers is to make transparencies (e.g., overhead projection transparencies) where a transparent receptor film is used as the medium to receive the image of the original. There is increasing demand for high performance transparent receptor film to be used, for example, as color overhead projection transparencies. Current commercial receptor media may consist of a polymeric substrate such as polyethylene terephthalate (PET) and one or more thin layers of organic coatings coated thereon for better imaging quality and feeding performance. Uncoated PET films may give poor toner adhesion and image quality and unreliable feeding performance.

Current commercial receptor media may be deficient in color fidelity, color density, toner adhesion, and scratch resistance. Unreliable transport of the media through the copier or printer due to inappropriate surface properties may also be a problem. Feedability may be an important design parameter because if the imaging media does not feed through a copier or printer none of the media's other qualities will be relevant.

Good toner adhesion may also be important. If the toner does not adhere well to the receptor layer, incomplete toner transfer from the photoconductor to the receptor layer may occur. This can result in hollow characters and poor image resolution. Poor toner adhesion may also result in images being abraded off during handling. Because transparencies are often used for overhead projection, designing a receptor layer that gives high image quality and a true projection of the original may be necessary. Poor color fidelity may be related to improper fusing of the toner particles in the toner-receptive coating. Good thermal and mechanical stabilities may also be necessary in order to avoid scratches, buckling, and loss of planarity during or after the converting, copying, and handling processes.

The problems of toner adhesion, image quality, unevenness of color quality/density, etc., may even be more significant with transparent media that are much thicker than conventional transparencies and have at least one textured, uneven or nonsmooth surface or side. An example of such transparent media are transparent lenticular lens materials. Lenticular lens materials provide or impart a lenticular image where the relative motion between the lenticular lens material and the viewer may produce any one of several image effects, including depth imaging, dynamic imaging, flip imaging, etc., depending upon the content of the composite image.

One side or surface of these lenticular lens materials comprises a plurality or array of lenticular lenses which impart a significant unevenness or lack of smoothness to that side or surface of the material. In cross-section, the side or surface of the material having this plurality or array of lenticular lenses appears as a series of hemispherical humps separated by valleys or grooves, while the other side or surface appears to be relatively smooth or flat. In addition, these transparent lenticular lens materials may have thickness greater than about 10 mils, for example, in the range of from about 13 to about 25 mils. As a result, electrophotographic transparent lenticular lens materials may be formed as sheets having a one relatively flat or smooth side and one side. Because of the combined greater thickness and greater surface unevenness, imparting color images to transparent lenticular lens materials by electrophotographic imaging processes with color toner particles that adhere adequately to these materials, provide an acceptable image quality and density and color impression, etc., may be a challenge.

### SUMMARY

According to a first broad aspect of the present invention, there is provided a composition comprising a coating composition comprising:
a polymeric toner particle adhesion agent; and
a surface resistivity adjustment agent;
wherein the coating composition provides a coating on a transparent thermoplastic electrophotographic recording medium having surface resistivity value of about 5×10¹³ ohms/square or less.

According to a second broad aspect of the present invention, there is provided an article comprising coated media comprising:
a transparent thermoplastic electrophotographic recording medium having a first side and a second side; and
a coating on at least one of the first and sides,
wherein the coating the coating has a surface resistivity value of about 5×10¹³ ohms/square or less and comprises a polymeric toner particle adhesion agent.

According to a third broad aspect of the present invention, there is provided an article comprising a coated lenticular lens electrophotographic recording medium comprising:
a transparent thermoplastic lenticular lens electrophotographic recording medium having a first side comprising an array of lenticular lenses and a second side having a relatively smooth surface; and
a coating on the second side, wherein the coating has a surface resistivity value of about 5×10¹³ ohms/square or less and comprises a polymeric toner particle adhesion agent.

According to a fourth broad aspect of the present invention, there is provided a method comprising the following steps of:
(a) providing a transparent thermoplastic electrophotographic recording medium having a first side and second sides; and
(b) coating at least one of the first and second sides with a coating composition, wherein the coating composition comprises a polymeric toner particle adhesion agent and provides a coating on the transparent thermoplastic electrophotographic recording medium having surface resistivity value of about 5×10¹³ ohms/square or less.

### BRIEF DESCRIPTION OF THE DRAWINGS

The invention will be described in conjunction with the accompanying drawings, in which:

FIG. 1 is a side sectional view showing an embodiment of a coated transparent thermoplastic electrophotographic recording medium of the present invention comprising transparency which is coated on one side or surface thereof; and

FIG. 2 is a side sectional view showing an embodiment of a coated transparent thermoplastic electrophotographic recording medium of the present invention comprising a lenticular lens material which is coated on the side of a sheet, wherein the side of the sheet has a relatively smooth or flat surface.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “electrophotographic recording media” refers to a media which is capable of recording an image an electrophotographic recording process. Electrophotographic recording media may be in the form of sheets, webs, strips, films, panes, pages, pieces, etc., which may be continuous in form (e.g., webs) for subsequent subdividing into discrete units, or which may be in the form of discrete units (e.g., a sheet).

For the purposes of the present invention, the term “electrophotographic recording process” refers to a process which records images on a media by xerography or electrophotography. In an electrophotographic process, the image is often formed on of the media by toner particles which are deposited one surface or side of the medium, and are then thermally fixed and/or fused to that one surface or side of the medium, for example, by heating. The electrophotographic recording medium may have two relatively smooth or flat sides or surfaces, or may have one side or surface which is textured, uneven or nonsmooth/nonflat, while the other side or surface is relatively smooth or flat.

For the purposes of the present invention, the term “transparent thermoplastic electrophotographic recording media” refers to electrophotographic recording media comprised of a transparent thermoplastic material. Transparent thermoplastic electrophotographic recording media may include, for example, transparencies (e.g., overhead projection transparencies), lenticular lens materials, etc.

For the purposes of the present invention, the term “thermoplastic” refers to the conventional meaning of thermoplastic, i.e., a composition, compound, material, etc., that exhibits the property of a material, such as a polymer, that softens when exposed to heat and generally returns to its original condition when cooled to room temperature. Suitable thermoplastics include, but are not limited to: acrylic-based polymers and copolymers, polyesters and copolyesteres (e.g., polyethyleneterephthalate), polysulfones, poly(vinylchloride), poly(vinyl acetate), poly(methyl vinyl ether-alt-maleic anhydride), polycarbonates, polymethylmethacrylate, cellulose esters, poly(styrene), poly(ethylene), poly(propylene), cyclic olefin polymers, poly(ethylene oxide), nylons, polyurethanes, protein polymers, UV curable resins, etc.

For the purposes of the present invention, the term “room temperature” refers to the commonly accepted meaning of room temperature, i.e., an ambient temperature of 20° to 25° C.

For the purposes of the present invention, the term “transparent” refers to the ability of a material to allow transmission of light therethrough.

For the purposes of the present invention, the term “lenticular lens material” refers to a material capable of forming lenticular images. Lenticular lens materials may comprise arrays of cylindrical lenses (known as lenticules or lenticular lenses) on one side or surface of the material, thus forming a textured, relatively uneven or nonsmooth/nonflat surface or side which, in cross-section, often appears as a series of hemispherical humps separated by valleys or grooves. The other side or surface of the lenticular may be relatively flat or smooth. A lenticular lens array has an associated array of composite strip images, with each lenticular lens presenting the viewer a selected portion of its strip image such that the combined presentation of all of the lenticular lenses presents a three-dimensional view of the scene, i.e., the lenticular image. The lenticular image usually occurs because of the relative motion between the lenticular lens material and the viewer which may produce any one of several lenticular image effects, including depth imaging, dynamic imaging, flip imaging, etc., depending upon the content of the composite image.

For the purposes of the present invention, the term “toner particles” refers to colorant particles used in, for example, printers (e.g., laser printers), photocopiers, etc., which form text and/or images on an electrophotographic recording media when fixed or fused thereon. Toner particles may comprise a mixture, blend, combination, etc., one or more colorant particles (e.g., of yellow, magenta, cyan, black or any combination thereof), and thermoplastic polymer particles which are thermally melted (e.g., by heating) by the printer, photocopier, etc., to fix or fuse the text and/or image on the media. The thermoplastic polymer particles may comprise styrene-acrylate copolymer, styrene-butyl methacrylate copolymer, a polyester resin, etc.

For the purposes of the present invention, the term “surface resistivity” refers to the degree to which a surface of an electrophotographic recording media attracts toner particles to that surface and is measure of the conductivity of that surface. Surface resistivity may be measured using a Keithley Model 617 autoranging picoameter with a Keithley Model 6105 resistivity adapter and a Keithley Model 247 high voltage supply. See U.S. Pat. No. 5,989,686 (Song et al.), issued Nov. 23, 1999 and ASTM D-4949 method, which are herein incorporated by reference in their entirety.

For the purposes of the present invention, the term “coating” refers to one or more layers, coverings, films, skins, etc., formed, created, prepared, etc., from a coating composition. The “coating” may or may not at least partially penetrate a surface of the substrate to which it is applied.

For the purposes of the present invention, the term “coating composition” refers to a composition comprising one or more polymeric toner particle adhesion agents, as well as other optional components, including surface resistivity adjustment agents, tackiness reducing agents, anti-static agents, solvents, diluents, anti-scratch and mar resistance agents, etc.

For the purposes of the present invention, the term “polymeric toner particle adhesion agents” refer to polymeric resins which are compatible with toner resin particles. Suitable polymeric toner particle adhesion agents for use herein include polyvinyl acetate and vinyl acetate/ethylene copolymers and resins (e.g., Airflex 460 and/or 144 from Air Products), various latexes, including styrene-butadiene latexes (e.g., Dow Latex XUR-YM-2005-229804), polyvinyl chloride, polyvinylidene chloride, polymethylmethacrylate, polychloroprene, hydroxyl modified copolymers of vinyl chloride and vinyl acetate, acrylic copolymers, chlorinated rubbers, starch and modified starch, protein polymers, etc. These polymeric toner particle adhesion agents may be included in the coating compositions in amounts of from about 65 to about 99.9% by weight, more typically in amounts of from about 80 to about 99.5% by weight, most typically in amounts of from about 95 to about 99% by weight of the coating. The amount of polymeric toner particle adhesion agents may be 65, 70, 75, 80, 85, 90, 91, 92, 93, 94, 95, 96, 97, 98, and 99.9% by weight of the coating, including any and all ranges and subranges therein.

For the purposes of the present invention, the term “surface resistivity adjustment agents” refer to a nonionic charge reducing agent. Suitable surface resistivity adjustment agents include polyethylene glycol M.W. (PEG 200), etc. Further examples include inorganic salts. Suitable inorganic salts may be monovalent and/or divalent and/or trivalent and may contain any level of hydration complexes thereof. Exemplified inorganic salts are those from Groups 1, 2 and 13 from the Periodic Table of Elements and hydrated complexes thereof, including monohydrates, dihydrates, trihydrates, tetrahydrates, etc. The cationic metal may be sodium, calcium, magnesium, and aluminum preferably. The anionic counterion to the cationic metal of the inorganic salt may be any halogen such as chloride, boride, fluoride, etc and/or hydroxyl group(s). The most preferred inorganic salt being sodium chloride. When the surface resistivity adjustment agent is at least one of the above-mentioned inorganic salts, it the surface resistivity adjustment agent may also serve a dual function as an anti-static agent (see below for description thereof). The surface resistivity adjustment agents may be included in the coating compositions in amounts of from about 0.01 to about 40% by weight, more typically in amounts of from about 0.05 to about 10% by weight; most typical in amounts of from about 0.1 to about 0.6% by weight of the coating composition. The amount of the surface resistivity adjustment agent may be 0.01, 0.02, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 15, 20, 25, 30, 35, and 40% by weight of the coating composition, including any and all ranges and subranges therein.

For the purposes of the present invention, the term “tackiness reducing agent” refers to particulates which reduce the contact area due to increased surface roughness. Suitable tackiness reducing agents may be particulate and include organic polymeric particulates and inorganic particulates. Polymeric particulates may include those comprising polyolefins, polystyrene, starch, polyurethane, poly(methyl methacrylate), polytetrafluoroethylene, etc. Inorganic particulates may include as alumina, silica (e.g., fumed silica), calcium carbonate, kaolin, aluminum hydroxide, etc. If alumina and/or silica is utilized, the primary particle size of the alumina and/or silica may be typically be less than 1000 microns, more typically less than 500 microns, typically less than 10 microns. The primary particle size may be 0.001, 0.005, 0.01, 0.05, 0.1, 0.2, 0.3, 0.4, 0.5, 0.6, 0.7, 0.8, 0.9, 1, 1.1, 1.2, 1.3, 1.4, 1.5, 2, 3, 4, 5, 6, 7, 8, 9, 10, 15, 20, 25, 30, 35, 40, 50, 100, 200, 500, and 1000 microns, including any and all ranges and subranges therein. These tackiness reducing agents may be included in the coating compositions in amounts of from 0 to about 25% by weight, more typically in amounts of from about 0.5 to about 10% by weight; most typically in amounts of from about 1 to about 5% by weight of the coating composition. The amount of the tackiness reducing agent may be 0, 0.1, 0.2, 0.3, 0.4, 0.5, 0.6, 0.7, 0.8, 0.9, 1, 2, 3, 4, 5, 6, 7, 8, 9, 10, 15, 20, and 25% by weight of the coating composition, including any and all ranges and subranges therein.

For the purposes of the present invention, the term “anti-static agents” refers to conductive materials which lower surface and volume resistivity. Suitable “anti-static agents” may include quaternary salt type cationic anti-static agents, for example, alkali metal and ammonium salts of poly-(styrene sulfonic acid), sulfonated styrene/maleic anhydride copolymer, poly(acrylic acid), poly(methacrylic acid), poly (vinyl phosphate) and free acids thereof, copolymers of dimethyl allyl ammonium chloride and diacetone acrylamide, quaternary acrylics, copolymers of dimethyl diallyl ammonium chloride and N-methylacrylamide, poly(dimethyl diallyl) ammonium chloride, quaternary cellulose acetate, etc. These anti-static agents may be included in the coating compositions in amounts of from about 0.5 to about 25% by weight, more typically in amounts of from about 1 to about 10% by weight. The amount of anti-static agent may be 0.5, 1, 2, 3, 4, 5, 6, 7, 8, 9, 10, 15, 20, and 25% by weight of the coating composition, including any and all ranges and subranges therein.

For the purposes of the present invention, the term “coating clarity” refers to the haze value of the coating, usually measured after the toner particles are fixed or fused onto the coating. Haze values for the coating may be measured by using a BYK GARDNER EL-211 Hazegard System. See U.S. Pat. No. 5,804,612 (Song et al.), issued Sep. 8, 1998, which is herein incorporated by reference in its entirety.

### DESCRIPTION

The present invention is directed broadly at coating compositions for transparent thermoplastic electrophotographic recording media, methods for coating such media with such compositions, as well as the coated media. These coating compositions provide a coating on the media having a surface resistivity value of about 1×10¹⁴ ohms/square or less, more typically about 5×10¹³ ohms/square or less. The surface resistivity may be at most 1×10¹⁴, 5×10¹³, 1×10¹³, 5×10¹², 1×10¹², 5×10¹¹, 1×10¹¹, and 5×10¹⁰ ohms/square, including any and all ranges and subranges therein. Because of the lower surface resistivity value the toner particles tend to adhere more tenaciously to the media so that the resultant text and/or image layer that is formed does not flake or fall off (in whole or in part), thus leading to improved image and/or color quality and density. The coating that is formed on the media also provides adequate transparency for coated media, even after the toner particles are fixed or fused to the coating during thermal treatment (e.g., heating) in the electrophotographic image process, and may be expressed as a haze value of about 5% or less.

These coating compositions further provide a coating on the media having a volume resistivity of not more than 1.0×10¹⁷ ohms-cm and typically less than 5.0×10¹⁶ ohms-cm. The volume resistivity may be at most 1.0×10¹⁷, 5.0×10¹⁶, 1.0×10¹⁶, 5.0×10¹⁵, 1.0×10¹⁵, 5.0×10¹⁴, 1.0×10¹⁴, and 5.0×10¹³ ohms-cm, including any and all ranges and subranges therein. “Volume resistivity” is also measured using a Keithley Model 617 autoranging picoameter with a Keithley Model 6105 resistivity adapter and a Keithley Model 247 high voltage supply. See U.S. Pat. No. 5,989,686 (Song et al.), issued Nov. 23, 1999 and ASTM D-4949 method, which are herein incorporated by reference in their entirety.

These coating compositions further provide for enhanced print density as measured using an X-Rite 518 Densitometer and as measured by TAPPI METHOD T 1213 sp-03. The SpectroDensitometer is, for example, set using the following settings: Status=T, auto color selection, absolute color. A sheet of plain white paper is placed on a flat surface and the printed coated media is placed on that paper with the smooth printed side facing up. The SpectroDensitometer is then placed on top of the smooth surface over a printed area and pressed down. The values are then read from the screen. This is repeated for the colors black, yellow, magenta and cyan.

As measured above, the coating composition provides for a black print density that is at least about 1.3, more typically at least about 1.5. The black print density may be at least about 1.3, 1.4, 1.5, 1.6, 1.7, 1.8, 1.9 and 2.0, including any and all ranges and subranges therein.

As measured above, the coating composition provides for a yellow print density that is at least about 0.70, more typically at least about 0.85. The yellow print density may be at least about 0.70, 0.75, 0.80, 0.85, 0.90, 0.95, and 1.0, including any and all ranges and subranges therein.

As measured above, the coating composition provides for a cyan print density that is at least about 1.2, more typically at least about 1.4. The cyan print density may be at least about 1.2, 1.3, 1.4, 1.5, 1.6, 1.7, 1.8, 1.9 and 2.0, including any and all ranges and subranges therein.

As measured above, the coating composition provides for a magenta print density that is at least about 0.85, more typically at least about 0.95. The magenta print density may be at least about 0.85, 0.90, 0.95, 1.0, 1.05, 1.1, and 1.2 including any and all ranges and subranges therein.

The present invention is particularly directed at coating transparent thermoplastic electrophotographic recording media, as well as the coated media, where the transparent thermoplastic electrophotographic recording media are relatively thick and have a textured side or surface which is relatively uneven and nonsmooth/nonflat, for example a lenticular lens material. These types of media may have thicknesses of about 10 mils or greater, for example, in the range of from about 13 to about 25 mils, more typically from about 15 to about 21 mils. The thickness may be at least about 10, 11, 12, 13, 14, 15, 16, 17, 18, 19, 20, 21, 22, 23, 24, and 25 mils, including any and all ranges and subranges therein. Because of the unevenness of one side of the media, it has been found that the problem of providing an acceptable image quality and density, as well as color impression is even more of a challenge than with transparent thermoplastic electrophotographic media that are thinner and where both sides of the media are relatively smooth and flat (e.g., standard transparencies). In particular, modifying the surface resistivity of the coating on such thicker transparent thermoplastic electrophotographic media such as lenticular lens materials may be even more important for achieving toner particle adhesion to the coating to provide acceptable image quality and density, color quality and impression, etc.

The coatings may be formed by depositing, applying, etc., the coating composition to the desired side or surface of the media by any number of coating methods. For example, coating methods that may be employed to form the coating on the media onto include roller coating, extrusion coating, wire-bar coating (e.g., by using a Meyer rod bar to draw down and smooth out the coating), dip-coating, rod coating, doctor coating, gravure coating, etc. Suitable coating weights may be in the range of from about 0.1 to about 3 grams per square meter, more typically from about 0.5 to about 2 grams per square meter. The coating weights may be about 0.1, 0.2, 0.3, 0.4, 0.5, 0.6, 0.7, 0.8, 0.9, 1.0, 1.1, 1.2, 1.3, 1.4, 1.5, 2, 2.5, and 3 grams per square meter, including any and all ranges and subranges therein.

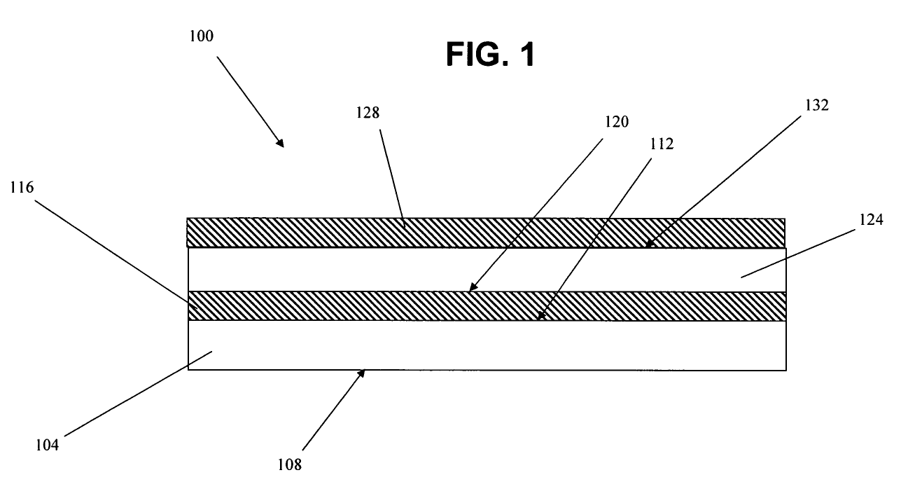

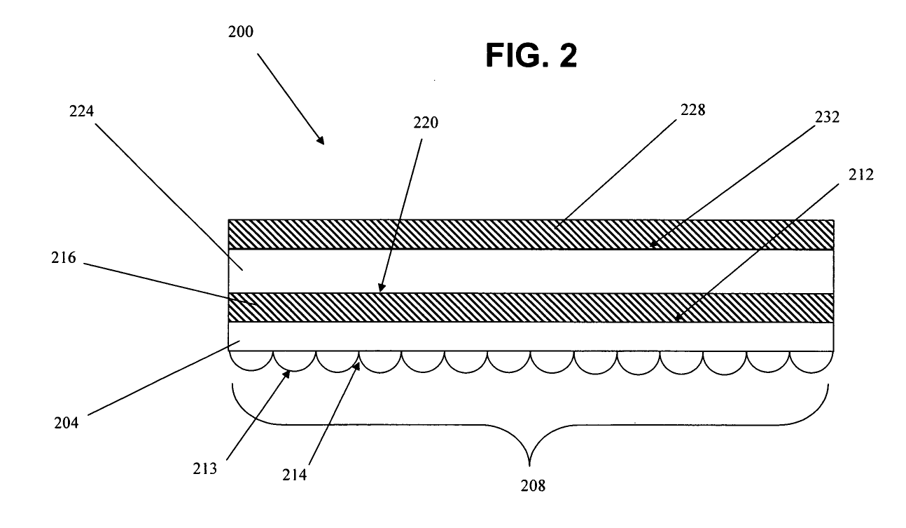

Embodiments of coated transparent thermoplastic media of the present invention are illustrated in FIGS. 1 and 2. Referring to FIG. 1, an embodiment of a coated transparent thermoplastic electrophotographic recording medium of the present invention is indicated generally as 100. Coated media 100 comprises a transparency sheet indicated generally as 104 and having a pair of spaced apart sides or surfaces indicated as 108 and 112. Sides/surfaces 108 and 112 of sheet 104 may each be relatively flat or smooth. Side or surface 112 represents the side or surface of sheet 104 which receives the coating composition. As shown in FIG. 1, a coating layer indicated generally as 116 is formed from the deposited coating composition on side or surface 112. As further shown in FIG. 1, the upper or outer side or surface of coating layer 116 indicated as 120 has toner particles deposited thereon during the electrophotographic imaging process in a printer, photocopier, etc. These toner particles are formed on side or surface 120 of coating layer 116 as a fixed or fused text and/or image layer indicated as 124 which has been formed by thermally melting the toner particles. As further shown in FIG. 1, a backing material, sheet, etc., indicated generally as 128 may be applied, adhered, etc., to upper or outer surface 132 of the text and/or image layer 124. Backing sheet 128 may be opaque and may be white or some other color. In addition, the coating composition may penetrate at least one surface of the substrate, in this case the transparency sheet, at varying degrees.

Referring to FIG. 2, another embodiment coated transparent thermoplastic electrophotographic recording medium of the present invention is indicated generally as 200. Coated medium 200 comprises a lenticular lens sheet indicated generally as 204 and having a pair of spaced apart sides or surfaces indicated as 208 and 212. Side or surface 208 comprises an array of lenticular lens which, as shown in FIG. 2, appears as a series of hemispherical humps 213 separated by valleys or grooves 214. Side/surface 212 of sheet 204 may be relatively flat or smooth. Side or surface 212 represents the side or surface of sheet 204 which receives the coating composition. As shown in FIG. 2, a coating layer indicated generally as 216 is formed from the deposited coating composition on side or surface 212. As further shown in FIG. 2, the upper or outer side or surface of coating layer 216 indicated as 220 has toner particles deposited thereon during the electrophotographic imaging process in a printer, photocopier, etc. These toner particles are formed on side or surface 220 of coating layer 216 as a fixed or fused text and/or image layer indicated as 224 which has been formed by thermally melting the toner particles. As further shown in FIG. 2, a backing material, sheet, etc., indicated generally as 228 may be applied, adhered, etc., to e upper or outer surface 232 of the text and/or image layer 224. Backing sheet 228 may be opaque and may be white or some other color. In addition, the coating composition may penetrate at least one surface of the substrate, in this case the lenticular lens sheet, at varying degrees.

It should be appreciated that the embodiments illustrated in FIGS. 1 through 2 are provided to illustrate the teachings of the present invention. Alterations or modification within the skill of the art of the embodiments in FIGS. 1 through 2 are considered within the scope of the present invention, so long as these alterations or modifications operate in a same or similar manner, function, etc.

### EXAMPLES

### Example 1

A coating composition comprising polyvinyl acetate (Airflex 460 from Air Products) as polymeric toner particle adhesion agent is used. The coating composition is applied to a transparent thermoplastic electrophotographic recording media (transparency sheet having a thickness of less than about 10 mils, or lenticular lens sheet having a thickness greater than about 10 mils) using a Meyer bar to spread the coating composition to a relatively uniform coating weight of from about 1 to about 3 grams per square meter.

### Example 2

A coating composition comprising 100 parts styrene-butadiene latex (Dow Latex XUR-YM-2005-229804) as polymeric toner particle adhesion agent, 5 parts Clariant PEG 200 as the surface resistivity adjustment agent, and 5 parts fumed silica (Sylojet P412 form W.R. Grace) is used. The coating composition is applied to a transparent thermoplastic electrophotographic recording media (transparency sheet having a thickness of less than about 10 mils, or lenticular lens sheet having a thickness greater than about 10 mils) using a Meyer bar to spread the coating composition to a relatively uniform coating weight of from about 1 to about 3 grams per square meter.

### Example 3

A coating composition comprising the formulations 0-3 in Table 1 below were applied made down to 20% solids in water and coated on 2 lenticular lens substrates (i.e. a Pacur Lenstar Lentucular 18 mils, 75 lpi and a Spartech APET Clear Lenticular Lens 22.8 mils, 50 lpi) at coat weights between 0.5 and 1.0 grams per square meter. The resultant surface resistivity, volume resistivity, and print densities are reported in Table 2 below

TABLE 1

| Chemical | 0 | 1 | 2 | 3 | 4 |
|---|---|---|---|---|---|
| Airflex 144 | uncoated | 100 | 96.7 | 96.5 | 96 |
| PEG 200 | uncoated | 5 | | | |
| Silojet 412 | uncoated | 3 | 3 | 3 | 3 |
| (micron | | | | | |
| sized | | | | | |
| silica) | | | | | |
| CaCl2 | uncoated | | 0.3 | 0.5 | 1 |

TABLE 2
Tested using ASTM-D-4949 test method

| | |
|---|---|
| Surface Resistivity | Volume Resistivity |
| (Ω/sq) | (Ω-cm) |

| | 18 mil | 22.8 mil | 18 mil | 22.8 mil |
|---|---|---|---|---|
| Coating | sheet | sheet | sheet | sheet |
| 0 | 2.3E+15 | 6.1E+14 | 1.9E+17 | 5.7E+17 |
| 1 | 2.9E+10 | 2.8E+10 | 6.2E+13 | 5.9E+13 |
| 2 | 1.4E+13 | 1.8E+13 | 1.5E+16 | 2.1E+16 |
| 3 | 1.0E+13 | 9.3E+12 | 1.8E+16 | 1.8E+16 |
| 4 | 7.0E+11 | 9.7E+11 | 2.1E+15 | 1.9E+15 |

TABLE 3
Tested using X-Rite 518 Densitometer 18 mil sheet only. The thicker
sheet did not feed in the printer due to thickness issues

| Coating | Black | Yellow | Cyan | Magenta |
|---|---|---|---|---|
| 0 | 1.65 | 0.65 | 1.13 | 0.8 |
| 1 | 1.36 | 0.85 | 0.83 | 0.83 |
| 2 | 1.62 | 0.94 | 1.36 | 1.05 |
| 3 | 1.53 | 0.87 | 1.41 | 1.05 |
| 4 | 1.58 | 0.69 | 1.49 | 0.97 |

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

As used throughout, ranges are used as a short hand for describing each and every value that is within the range, including all subranges therein.

Further features of the present invention are described in the following documents attached hereto as appendices and which are hereby incorporated by reference herein in their entireties. It should be understood that embodiments and features of the present invention may be combined with any other features or embodiments described in the documents attached hereto and/or incorporated by reference herein as long as such combinations are possible and non-conflicting.

What is claimed is:

1. A composition comprising a coating composition comprising:
a polymeric toner particle adhesion agent; and
a surface resistivity adjustment agent;
wherein the coating composition provides a coating on a transparent thermoplastic electrophotographic recording media having surface resistivity value of about 1×10¹⁴ ohms/square or less.

2. The composition of claim 1, wherein the polymeric toner particle adhesion agent comprises a polyvinyl acetate resin or a styrene-butadiene latex

3. The composition of claim 1, wherein the surface resistivity adjustment agent comprises PEG 200, calcium chloride, or mixtures thereof.

4. The composition of claim 1, which further comprises a tackiness reducing agent.

5. The composition of claim 4, wherein the tackiness reducing agent comprises fumed silica.

6. The composition of claim 1, which further comprises an anti-static agent.

7. The composition of claim 1, wherein the coating provided has a surface resistivity value of about 5×10¹³ ohms/square or less.

8. The composition of claim 1, wherein the coating provided has a haze value of about 5% or less.

9. An article comprising a coated medium comprising:
a transparent thermoplastic electrophotographic recording medium having a first side and a second side; and
a coating on at least one of the first and sides,
wherein the coating the coating has a surface resistivity value of about 1×10¹⁴ ohms/square or less and comprises a polymeric toner particle adhesion agent.

10. The article of claim 9, wherein the coating has a surface resistivity value of about 5×10¹³ ohms/square or less.

11. The article of claim 9, wherein the coating has a haze value of about 5% or less.

12. The article of claim 9, wherein the coating further comprises a surface resistivity adjustment agent.

13. The article of claim 9, wherein the coating further comprises a tackiness reducing agent.

14. The article of claim 9, wherein the coating further comprises an anti-static agent.

15. The article of claim 9, wherein the transparent thermoplastic electrophotographic recording medium comprises a sheet.

16. An article comprising a coated lenticular lens electrophotographic recording medium comprising:
a transparent thermoplastic lenticular lens electrophotographic recording medium having a first side comprising an array of lenticular lenses and a second side having a relatively smooth surface; and
a coating on the second side, wherein the coating has a surface resistivity value of about 5×10¹³ ohms/square or less and comprises a polymeric toner particle adhesion agent.

17. The article of claim 16, wherein the coating has a surface resistivity value of about 5×10¹² ohms/square or less.

18. The article of claim 16, wherein the coating has a haze value of about 5% or less.

19. The article of claim 16, wherein the coating further comprises a surface resistivity adjustment agent.

20. The article of claim 16, wherein the coating further comprises a tackiness reducing agent.

21. The article of claim 16, wherein the coating further comprises an anti-static agent.

22. The article of claim 16, wherein the transparent thermoplastic lenticular lens electrophotographic recording medium comprises a sheet.

23. The article of claim 16, wherein the transparent thermoplastic lenticular lens electrophotographic recording medium has thickness of about 10 mils or greater.

24. The article of claim 23, wherein the thickness is in the range of from about 13 to about 25 mils.

25. A method comprising the following steps:
(a) providing a transparent thermoplastic electrophotographic recording medium having a first side and second sides; and
(b) coating at least one of the first and second sides with a coating composition, wherein the coating composition comprises a polymeric toner particle adhesion agent and provides a coating on the transparent thermoplastic electrophotographic recording medium having surface resistivity value of about 5×10¹³ ohms/square or less.

26. The method of claim 25, wherein step (b) is carried out by applying the coating composition to one of the first and second sides.

27. The method of claim 26, wherein step (b) is carried out by wire-bar coating.
